(19) United States
(12) Patent Application Publication
(10) Pub. No.: US 2007/0112678 A1
(43) Pub. Date: May 17, 2007

(54) Method and System for Operating a Secondary Market for Digital Music

(75) Inventor: Matthew M. Himelfarb, Dallas, TX (US)

Correspondence Address: Matthew Himelfarb, 6630 Waggoner Drive, Dallas, TX, 75230, US

(73) Assignee: MSHARES, INC, Dallas, TX (US)

(21) Appl. No.: 11/558,930

(22) Filed: Nov. 12, 2006

Related U.S. Application Data
(60) Provisional application No. 60/737,316, filed on Nov. 15, 2005.

(51) Int. Cl. G06Q 99/00; H04L 9/00; H04K 1/00

(52) U.S. Cl. 705/51

(57) ABSTRACT

A system is disclosed that operates a secondary market for digital music licenses. The system includes a license administration center communicating over a network with a content provider, a selling first consumer, and a purchasing second consumer. The license administration center operates to receive bids and offers for digital music licenses from the first consumer and second consumer, match bids and offers, terminate the digital music license of the first consumer, grant the digital music license to the second consumer, provide consideration to the first consumer, and receive consideration from the second consumer.

### CROSS-REFERENCE TO RELATED APPLICATIONS

This application claims priority under 35 U.S.C. §119 to U.S. Provisional Patent Application Ser. No. 60/737,316 entitled “Method and System for Online Digital Music Trading” filed Nov. 15, 2005.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates to a method and system for operating a secondary market for digital music licenses.

2. Description of Related Art

The music industry generated over $11 billion in sales in 2004 within the United States, and over $35 billion worldwide. Ninety-three percent of such revenue was generated through compact disc sales. Despite these impressive statistics, sales growth for record labels has stagnated. Though digital music distributions systems offer the potential for low-cost, high-margin sales to supplement flagging convention sales, such digital systems suffer from their own substantial limitations. Existing digital music distribution systems come in many forms.

Peer-2-Peer networks, such as those operated using software developed by Kazaa^{SM} and Grokster^{SM}, offer the ability to distribute music files (among other file types) between network users without cost following the initial purchase or acquisition of the required software. Consumers suffer from a high risk of violating copyright laws, potential poor music quality, and security risks. Content providers (i.e. record labels, music distributors, and their artists) suffer far worse, as they receive no compensation for the use of their product.

Pay-per-download systems, as exemplified by iTunes®, integrates a media player program, a download service, and a portable player, and iTunes® currently controls approximately seventy percent (70%) of the single song download market. Advantages of such systems are the cost of software (typically free) and the large catalog of songs available for legal download. Weaknesses, on the other hand, include a reduced revenue potential for record labels and artists, inoperability between systems and file formats, and credit card fees that consume a larger percentage of sale price for lower priced song sales than for higher priced album sales.

Subscription based systems, such as Napster® and Real Rhapsody®, offer unlimited song use over a large catalog. However, subscriptions costs are relatively high, and a consumer may no longer use song content once the subscription expires. In addition, the mechanisms by which record labels, and therefore artists, are compensated are typically based upon catalog size, providing little incentive for small record labels and emerging artists.

### BRIEF SUMMARY OF THE INVENTION

In accordance with the present invention, a system for operating a secondary market for digital music licenses is provided (“the Mshares system”) which combines the benefits of subscription and pay-per-download systems.

In one embodiment of the invention, a license administration center, the operator of the Mshares system, comprises a memory, a processor coupled to the memory, and a computer program stored in the memory. The computer program is operable, when executed on the processor, to receive an offer for the sale of a first digital music license from a first consumer, and to receive a bid for the purchase of a second digital music license from a second consumer. The first and second digital music licenses correspond to one another, and preferably correspond by being associated with the same musical artist. Each digital music license may be considered a share, or “Mshare” of such artist. The computer program is also operable to match the offer of the first consumer with the bid of the second consumer, grant the second digital music license, and terminate the first digital music license. The computer program completes the transaction by obtaining consideration from the second consumer for the purchase of the second digital music license, and providing consideration to the first consumer for the sale of the first digital music license.

In a preferred embodiment, a consumer purchasing a digital music license, which is associated with a music artist, may assign that digital music license to any album of such artist, and is thereafter permitted to play music files associated with such album and obtained through the present invention until such time as the consumer sells the digital music license. At that time the first consumer loses his rights to play the associated music files, and the purchasing consumer gains such rights. In this way the present invention performs as a type of subscription-based system, except that the subscription is artist or album specific, instead of for a fixed time frame. In addition, the consumer realizes a benefit through the sale of the digital music license on the secondary market. This use of music rights as an opportunity to recoup the purchase price of music is a benefit previously unknown to any digital music distribution system. A consumer may also elect while possessing a digital music license to obtain a supplemental license for any song(s) on the album. Should a consumer obtain a supplemental license, then the benefit realized by the consumer through a subsequent sale on the secondary market would be reduced to reflect to purchase price of the supplemental music licenses. In this manner the present invention system performs as a type of pay-per download system. This combination offers myriad benefits to content providers and consumers relative to existing systems.

With respect to content providers, the present invention offers both increased revenue opportunities and a powerful sales tool. Content providers derive revenue from the system through three means, primary markets for digital music licenses, secondary markets for digital music licenses, and supplemental license sales (individual song downloads). First, a content provider receives revenue based upon primary market sales. Primary market sales are those in which digital music licenses are sold directly from the license administration center or the content provider to consumers via the present invention, during an initial offering of digital music licenses, preferably associated with a particular artist. Second, a content provider receives revenue based upon the secondary market sales. Secondary market sales are those in which digital music licenses are sold from one consumer to a second consumer via the present invention. Finally, a content provider receives revenue based upon the sale of supplemental licenses to consumers. Such revenue is preferably realized in conjunction with secondary market sales, with fees charged for supplemental licenses reducing the benefit realized by a selling consumer from a sale on the secondary market. The collective revenue potential from these three revenue streams should substantially exceed that offered through alternate digital music distribution systems.

The present invention also represents a powerful sales tool for content providers, especially with respect to emerging artists. This result is realized because consumers are motivated not only by their desire to consume music, but also by the opportunity to realize gain on purchased music. Digital music license appreciation of this type can be realized either monetarily, through an opportunity to increase the consumer's music library at no additional cost or reduced costs, or through alternate benefits. The present invention should prove particularly attractive to music aficionados (who believe their knowledge of artists to be an advantage), and game enthusiasts (who simply enjoy competition). These additional incentives are particularly attractive for emerging artists and independent record labels. Such content providers have been underserved by existing digital music distribution systems, and their digital music licenses have the potential for large growth as their corresponding albums gain mainstream popularity.

The present invention may also serve to increase sales derived from less popular artists, as secondary market factors should decrease the price of digital music licenses and supplemental licenses associated with such artists, until demand increases.

Finally, the present invention, by creating a pecuniary interest for digital music consumers, motivates those consumers to utilize legal digital music distribution systems, and offers one means by which content providers can battle music piracy.

With respect to consumers, the present invention offers music consumption at a competitive price, the ability to realize gain through the secondary market, and the added enjoyment of participating in a competitive community for music aficionados.

Though the original purchase price of a digital music license may exceed the price of an album purchased through retail establishments or pay-per-download systems, the effective price for a supplemental license in many cases is substantially lowered by utilization of the present invention. The effective price for a supplemental license may be calculated by reducing the original purchase price of the relevant digital music license by the benefit realized by a consumer selling the digital music license on the secondary market, and then dividing the reduced price by the number of supplemental licenses purchased from relevant album associated with the digital music license. A consumer also derives the additional benefit of being permitted to listen to all songs on the relevant album while the digital music license is possessed by the consumer.

If a digital music license appreciates sufficiently while being held by a consumer, the consumer's effective price for a supplemental music license may be less than zero, and whether or not the consumer obtained any supplemental music licenses, he or she may realize appreciation on the sale.

As previously explained, the process of utilizing the secondary market for digital music licenses should also prove enjoyable to consumers, particularly music aficionados and game enthusiasts.

The present invention also offers an opportunity for the license administration center to realize revenue. The license administration center may be a third party independent of content providers, may be a single content provider, or may be an organization of multiple content providers. The license administration center may charge consumers a subscription fee comparable to that charged by subscription based systems. The administrator may also charge a fee in association with any sale of a digital music license. Such fees may be: (a) on a per-transaction basis or a per-digital music license basis; (b) fixed or based upon a percentage of the consideration to be provided to or received from a consumer in a transaction; and (c) charged against content provider revenue or consumer consideration. Additional fees may be charged for supplemental music licenses obtained by consumers, if any.

### BRIEF DESCRIPTION OF THE SEVERAL VIEWS OF THE DRAWINGS

For a more complete understanding of the present invention and the advantages thereof, reference is now made to the following descriptions, taken in conjunction with the accompanying drawings, in which:

FIG. 1 is a block diagram illustrating a system for operating a secondary market for digital music licenses in accordance with the teachings of the present invention;

FIG. 2 illustrates an exemplary license administration center from the system of FIG. 1;

FIG. 3 is a flowchart of a method for operating a secondary market for digital music licenses;

FIG. 4 is a flowchart of a preferred embodiment of operating the method of FIG. 3.

### DETAILED DESCRIPTION OF THE INVENTION

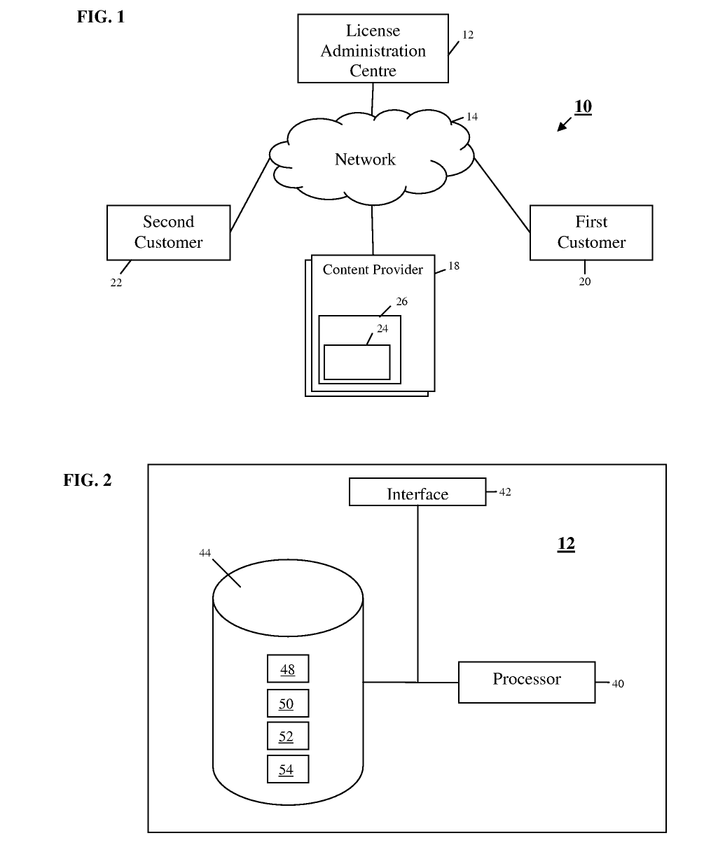

The preferred embodiments of the present invention and its advantages are best understood by referring now in more detail to FIGS. 1, 2, 3, and 4 of the drawings, in which like numerals refer to like parts.

FIG. 1 illustrates a system 10 for operating a variably-priced secondary market for digital music that includes a license administration center 12 coupled to a network 14. License administration center 12 communicates with a content provider 18, a first consumer 20, and a second consumer 22 using network 14. In general, license administration center 12 manages digital music licenses to play music files warehoused by the content provider 18 among first consumer 20, second consumer 22, and other consumers.

Content provider 18 represents communications and/or processing equipment used or maintained by any music label, music distributor, music retailer, or other provider of music products, products being any type of music goods or services offered for sale, including music-related metadata, and includes a music file warehouse 24 within a memory 26. First consumer 20 represents communications and/or processing equipment used or maintained by any entity that purchases digital music licenses through administration center 12 for playing music files warehoused by content provider 18. Second consumer 22 represents communications and/or processing equipment used or maintained by any entity that purchases digital music licenses through license administration center 12 for playing music files warehoused by content provider 18, including a memory for storing music files. Network 14 may be any collection and arrangement of hardware and/or software allowing electronic communications between components in system 10. For example, network 14 may be one or a collection of components associated with the public switched telephone network, local area networks, wide area networks, a global computer network such as the Internet, the World Wide Web, or any other suitable wireline or wireless communications technology. Throughout this description, content provider 18, first consumer 20, and second consumer 22 refer to communications and/or processing equipment or to the user of this equipment, as appropriate.

According to one embodiment, license administration center 12 contains a web server, network 14 is the Internet, content provider 18 contains a webs server, and first consumer 20 and second consumer 22 represent web browsers or other suitable interface to communicate information with license administration center 12 using network 14.

In operation, license administration center 12 grants and terminates digital music licenses among consumers, including first consumer 20 and second consumer 22. License administration center 12 grants digital music licenses in exchange for consideration received from the relevant buying consumer. License administration center 12 terminates digital music licenses as a consequence of the sale of the digital music license by the relevant selling consumer in exchange for consideration paid to the selling consumer.

Although not shown, system 10 may include a number of networked or stand-alone license administration centers 12 arranged by geography, for land balancing or in other suitable configurations. Although not shown, content provider 18 may also be included within license administration center 12.

FIG. 2 illustrates license administration center 12 that includes a processor 40 coupled to an interface 42 and a memory 44. Interface 42 represents any suitable communications software and/or hardware for interfacing with local and/or remote locations. In those embodiments in which content provider 18 is included within license administration center 12, memory 26 may equate to, or be included within, memory 44. Memory 44 represents any one or combination of volatile or non-volatile, local or remote devices suitable for storing data. For example, memory 44 could be composed of random access memory (RAM) devices, magnetic storage devices, read only memory (ROM) devices, optical storage devices, or any other suitable data storage devices. Processor 40 represents any device or combination of devices, local or remote, operating alone or in concert through, for example, distributed processing, load balancing, threaded processing, or any other suitable processing techniques. License administration center 12 can be implemented with any suitable controlling hardware, software, or combination of hardware and software.

In operation, processor 40 executes a program 48 stored on memory 44. Program 48 controls communication between interface 42 and other devices, such as content provider 18, first consumer 20, and second consumer 22. Moreover, program 48 controls access to and population of a license table 50 stored in memory 44, and operates the consumer driven variably-priced, secondary market (the “market”) for digital music licenses. Program 48 may be stored on any portion of memory 44 and may be executed using any suitable technique on processor 40. This may be on a device or combination of devices, local or remote, operating alone or in concert through, for example, distributed processing, load balancing, threaded processing, or any other suitable processing techniques. In a particular embodiment, first consumer 20 and second consumer 22, among other consumers, access license administration center 12 over the World Wide Web to offer to sell, bid to buy, sell, and buy digital music licenses through the market. However, system 10 contemplates other techniques for interfacing, such as a proprietary interface or telephone systems.

License table 50 maintains a list of granted and outstanding digital music licenses, the music files associated with the such digital music licenses (if any), and the consumers holding such digital music licenses. Consumers may be identified within license table 50 by an identifier assigned to such consumer by program 48, an identifier provided by the consumer, such as a social security number or username, an IP address associated with the consumer, or hardware associated with the consumer, such as the consumer's computer.

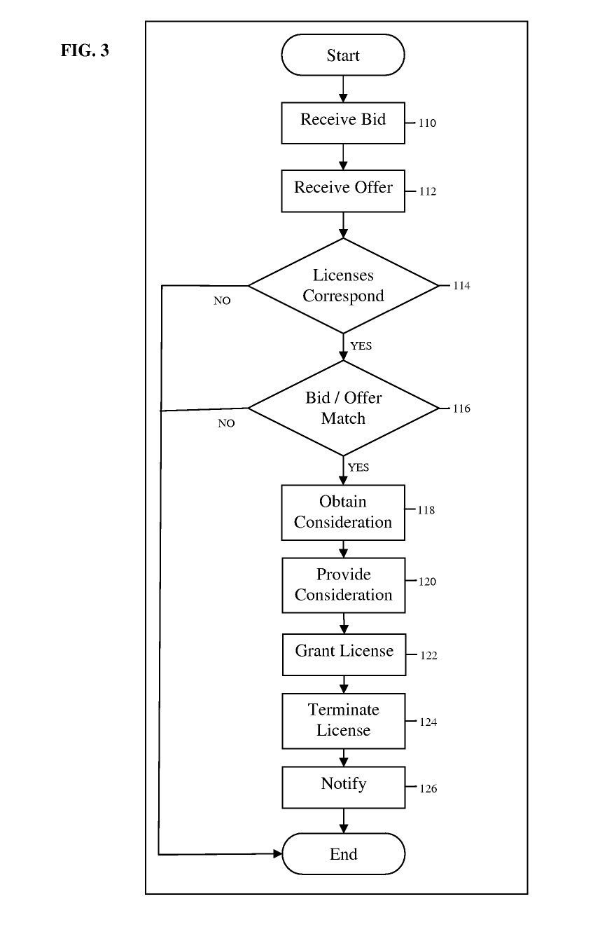

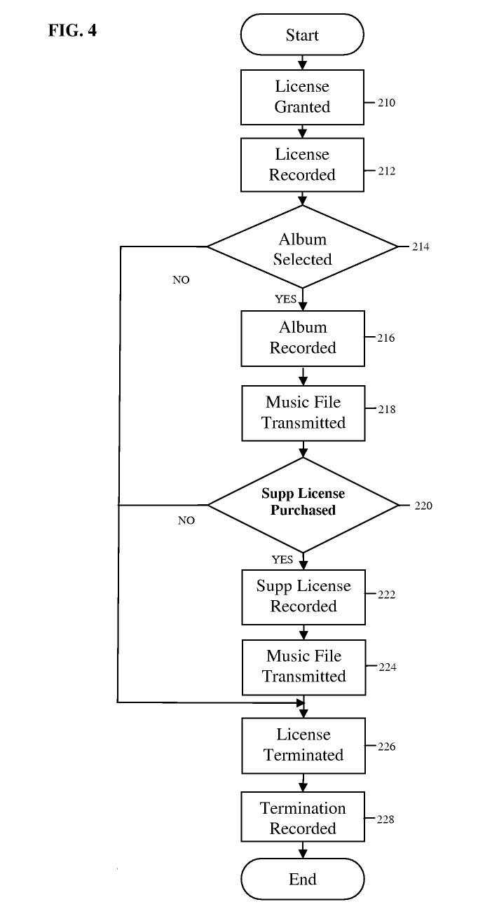

In a preferred embodiment, memory 44 further stores a first monetary account 54 associated with first consumer 20, and a second monetary account 52 associated with second consumer 22. Program 48 operates to receive consideration from second consumer 22 from second monetary account 52, following any successful bid to purchase a second music license in the market, and to deposit consideration for first consumer 20 into first monetary account 54, following any successful offer to sell a first music license in the market. The operation by license administration center 12 of the market is described in the methods of FIG. 3 and FIG. 4 below.

FIG. 3 is a flowchart illustrating a method for operating a variably-priced secondary market for digital music licenses. License administration center 12 receives an offer to sell, for a sale price, a first digital music license from first consumer 20 at step 110. License administration center 12 receives a bid to purchase, at a purchase price, a second digital music license at step 112. License administration center 12 determines in step 114 if the first digital music license corresponds with the second digital music license. If so, license administration center 12 determines in step 116 if the bid purchase price of second consumer is greater than or equal to the offered sale price of first consumer 20. If so, license administration center 12 proceeds to step 118. If it is determined in step 114 that the first digital music license does not correspond to the second digital music license, or it is determined in step 116 that the bid purchase price of second consumer 22 is less than the offered sale price of first consumer 20, then license administration center 12 skips to the end of the process. In the preferred embodiment, license administration center 12 then repeats the process of FIG. 3 using the offered sale price of first consumer 20 and all other pending bid purchase prices of other consumers received by license administration center 12 (“alternate bids”), or the bid purchase price of second consumer 22 and all other pending offered sales prices of other consumers received by license administration center 12 (“alternate offers”). Where no combination of the offered sales price of first consumer 20 and alternate bids satisfies steps 114 and 116, then the first digital music license is not sold by first consumer 20 in the market. Where no combination of the bid purchase price of second consumer 22 and alternate offers satisfies steps 114 and 116, then the first digital music license is not purchased by second consumer 22 in the market. This process can be repeated, automatically or at the request of the relevant consumer, until a transaction is completed successfully or the relevant consumer withdraws its offer or bid. In this manner the actual sale price and purchase price experienced in the market are influenced by consumer participants in the market.

In a preferred embodiment, correspondence between the first digital music license and the second digital music license in step 114 occurs when both licenses are associated with a single artist. Such artist may be an individual, a group of individuals (e.g. a band), or a business entity.

In step 118, license administration center 12 obtains consideration from second consumer 22 for the second digital music license. In a preferred embodiment the consideration received from second consumer 22 is deducted by license administration center 12 from second monetary account 52, and the license administration center confirms the existence of consideration equal to or greater than the bid purchase price of second consumer 22 prior to permitting second consumer 22 to communicate the bid of step 110. In an alternate embodiment, consideration is paid by second consumer 22 via a credit card transaction, or similar payment vehicle.

The license administration center 12 then proceeds to step 120, and provides consideration to first consumer 20 for the sale of the first digital music license. The consideration paid to first consumer 20 in step 120 is less than or equal to the consideration received from second consumer 20 in step 118. The consideration paid to first consumer 20 may be less than the consideration received from second consumer 22 in step 118, due to the deduction of fees from the consideration received by the license administration center 12. Such fees may represent a fixed amount per transaction, a percentage of the consideration received from second consumer 22, a percentage of the consideration paid to first consumer 20, or some other amount. Fees may be payable to the operator of license administration center 12, content provider 18, and other third parties.

In a preferred embodiment: (a) first consumer 20 is provided eighty percent (80%) of the consideration received from second consumer 22, less a $0.50 fee retained by license administration center 12, and (b) content provider 18, or the copyright holders of the relevant musical files if content provider 18 is merely a distributor for such copyright holders, is provided twenty percent (20%) of the consideration. In alternate embodiments: the fee paid to license administration center 12 is a fraction of the relevant digital music license's sale price; the fee is charged to content provider 18 in lieu of first consumer 20, or to both content provider 18 and first consumer 12; no fee is paid to license administration center 12, or percent distributions between first consumer 20 and content provider 18 are utilized other than the 80/20 distribution described above.

In a preferred embodiment the consideration provided to first consumer 20 is deposited by license administration center 12 into first monetary account 54. In an alternate embodiment, consideration is provided to first consumer 20 via direct deposit into an account maintained by first consumer 20 with a financial institution.

License administration center 12 then proceeds to step 122, and grants the second digital music license to second consumer 22, using a process as described in FIG. 4.

License administration center 12 then proceeds to step 124, and terminates the first digital music license of first consumer 20, using a process as described in FIG. 4.

In a preferred embodiment, license administration center 12, then proceeds to step 126, and notifies first consumer 20 and second consumer 22 of the successful transaction.

The ordering of steps 118,120,122,124, and 126 is flexible, and may be established at the discretion of the operator of license administration center 12.

FIG. 4 is a flowchart illustrating a preferred embodiment of steps 122 and 124 of FIG. 3, and the use by first consumer 20 of the first digital music license between the purchase of such license and its sale.

First consumer 20 is granted a first digital music license in step 210 as a result of a purchase accomplished through either (a) the variably-priced secondary market of system 10, as described in FIG. 3; or (b) through a primary market for digital music licenses operated by license administration center 12. In primary market transactions, a number of corresponding digital music licenses are offered for sale. The number of digital music shares offered in such sale may be determined by license administration center 12 alone, content provider 18, or music copyright holders, among others, so as achieve desired price for such digital music licenses on the market.

In a preferred embodiment, content provider 18 receive one hundred percent (100%) of proceeds from primary market sales, less a small fixed transaction fee paid to license administration center 12. In the preferred embodiment, the fee paid to license administration center 12 from primary market sales, and from secondary market sales as provided in the method of FIG. 3, is $0.50, unless the price for the relevant digital music licenses is less than $5, in which case the fee paid to license administration center 12 is equal to ten percent (10%) of the price of the relevant digital music license. In an alternate embodiment, the fee paid to license administration center 12 in association with primary market sales is always a fraction of relevant digital music license's sale price. In another alternate embodiment, no fee is paid to license administration center 12 in association with primary market sales.

Next, in step 212, license administration center 12 records the grant of step 210 in license table 50.

In the preferred embodiment, the first digital music license is associated with an artist, and all corresponding digital music licenses are also associated with the same artist. The first digital music license grants first consumer 20 the right to make a one-time selection of any album from the artist's collection which is contained within music file warehouse 24 (a “qualifying album”), and play music files associated with such qualifying album as provided in step 218 below. In an alternate embodiment, first consumer 20 may switch the qualifying album associated with the first digital music license through subsequent selections while first consumer 20 owns the first digital music license. In other alternate embodiments, the first digital music license is associated with an album (an “album license”), not an artist, and the album license grants first consumer 20 the right to play music files associated with such album. In the preferred embodiment, digital music licenses that may be assigned to select artists do not require assignment to a specific album, and instead grant first consumer 20 the right to play all music files contained within music file warehouse 24 (a “library license”). The music files of artists who are no longer producing new music may be particularly appropriate for the use of library licenses.

Subsequently, in step 214, license administration center 12 may receive information from first consumer 20 indicating the selection by first consumer 20 of a qualifying album. In the preferred embodiment, first consumer 20 is not required to select an album, and if no album is selected license administration center 12 skips to step 226 (though any length of time may pass between step 212 and step 226). In an alternate embodiment, license administration center 12 requires first consumer 20 to select an album associated with the artist prior to or in conjunction with making a bid for the purchase of the first digital music license, in which case step 214 would occur prior to the license grant of step 210.

If an album selection request is received in step 214, license administration center 12 proceeds to step 216, and records the assignment of the first digital music license to the selected qualifying album in license table 50.

In step 218, license administration center 12 causes one or more music files (“qualifying music files”) associated with the selected qualifying album of the first digital music license to be transmitted from content provider 18 to first consumer 20 via the network. Qualifying music files may also include all music files associated with an album license or a library license. Qualifying music files may be transmitted and stored for future play (“downloaded”), or may be transmitted for immediate or near-immediate play using real-time or progressive streaming techniques. Where real-time streaming techniques are utilized, the music file may not be a discrete music file, but may instead by a stream of music data. Downloading may also be done on a “progressive” basis, wherein the music file may be played, to the extent already downloaded, prior to the completion of the downloading process.

In the preferred embodiment, progressive downloading is utilized to transmit qualifying music files to first consumer 20 upon request as communicated by first consumer 20 to license administration center 12, and qualifying music files are played by first consumer 20 using a proprietary web interface provided by license administration center 12. Following receipt of such a demand, license administration center 12 transmits information to content provider 18, instructing content provider 18 to transmit the requested qualifying music file directly to first consumer 20. In alternate embodiments, requested qualifying music file is transmitted from content provider 18 to license administration center 12, and then from license administration center 12 to first consumer 20.

In alternate embodiments, all qualifying music files are downloaded to first consumer 20 upon the request of first consumer 20, or automatically following first consumer 20's selection of a qualifying license, or purchase of a library license or album license. In other alternate embodiments, individual music files are transmitted as requested by first consumer 20.

In preferred embodiments where qualifying music files are downloaded to first consumer 20, such files include, or are accompanied by, software managing use of the music files in accordance with the first digital music license (“license software”). License software may be incorporate within a proprietary music player that is used to play music files.

In the preferred embodiment, where progressive downloading is utilized to transmit music files to first consumer 20, upon any attempt by first consumer 20 to play a music file associated with the first digital music license, the license software accesses license administration center 12, to confirm through reference to license table 50, that first consumer 20 is still the owner of the first digital music license. License software may restrict the number of copies of the relevant qualifying music file which may be made by first consumer 20, or the number of devices which may be used to play such files, among other restrictions. The software may also terminate the right of first consumer 20 to play the relevant qualifying music file, as provided in step 226 below.

In alternate embodiments, license software is transmitted to first consumer 20 by license administration center 12, or content provider 18 in response to instructions received from license administration center 12, prior to the transmission to first consumer 20 of the relevant qualifying music file. License software is subsequently accessed by content provider 18 using network 14 to confirm the right of first consumer 20 to request the transmission of the relevant qualifying music file.

Subsequently, in step 220, license administration center 12 may receive a request from first consumer 20 to purchase a supplemental digital music license (a “supplemental license”) for the song associated with a qualifying music files. In the preferred embodiment, first consumer 20 is not required to request the purchase of any supplemental license, and if no album is selected license administration center 12 skips to step 226 (though any length of time may pass between step 218 and step 226).

A supplemental license permits first consumer 20 to play an associated qualifying music file after the termination of the first digital musical license in step 226 below, which may be the same qualifying music file transmitted in step 218, or an alternate qualifying music file featuring the same musical work or song. A supplemental license may also grant rights greater than those granted under the first digital music license even before the termination of the first digital music license in step 226 below, such as the right to burn the associated qualifying music file to compact disk, or the right to play such file with portable music players. A supplemental license may also modify the manner in which qualifying music files are downloaded to and played by first consumer 20. Additional rights granted in association with a supplemental license may be provided to first consumer 20 immediately upon the purchase of the supplemental license, at any time thereafter upon the request of first consumer 20, or in association with the termination of the first digital music license as provided in step 226 below. In the preferred embodiment, even though a supplemental license permits first consumer 20 to play the associated music file after termination of the first music license in step 226, license administration center still retains the legal right to terminate the supplemental license should first consumer 20 violate the legal terms and conditions of the supplemental license or the first digital music license.

If a request for the purchase of a supplemental license is received in step 220, license administration center 12 proceeds to step 222, and records the purchase of the supplemental license in license table 50.

In step 224, license administration center 12 causes one or more qualifying music files associated with the selected qualifying album of the first digital music license to be transmitted from content provider 18 to first consumer 20 via the network. Any system or method for performing step 218 may be used for step 224. Step 224 may occur immediately following step 220, at any time thereafter upon the request of first consumer 20, or in association with the termination of the first digital music license as provided in step 226 below.

In the preferred embodiment, in which progressive downloading is utilized in step 218, license administration center 12, immediately following step 222, downloads an alternative digital music file (“alternative file”) with license software which permits first consumer 20 to: (i) play the alternative file without the use of a proprietary web interface of license administration center 12, (ii) burn a fixed number of copies of the alternative file to compact disk; and (iii) play the alternative file using portable music devices.

In alternate embodiments, in which any form of downloading has been used to provide a music file to first consumer 20, and license software is also being used, the purchase by first consumer 20 of a supplemental license triggers license administration center 12 (or content provider 18 in response to instructions received from license administration center 12) to modify the license software to permit play of the qualified music file after termination of the first digital music license in step 226 below.

If first consumer 20 purchases one or more supplemental licenses, consideration may be paid in any manner described in step 118 of the method of FIG. 3. The payment of consideration in association with the purchase of a supplemental license may occur in conjunction with step 220 or at any time thereafter. In preferred embodiments, consideration is paid through a reduction in the consideration provided to first consumer 20 in step 120 of the method of FIG. 3, and for every music file specific supplemental license purchased the revenue which otherwise would be provided to first consumer 20 is reduced by a certain percentage.

In the preferred embodiment, the supplemental license purchase price is equal to eight percent (8%) of the consideration first consumer 20 would have received (the “potential consideration”), prior to the application of the $0.50 fees assessed by the license administration center 12. Thus, in the preferred embodiment, where the market price for the first digital music license is $10, the potential consideration first consumer 20 would have received is eighty percent (80%) of the consideration or $8, and, the supplemental license purchase price would be eight percent (8%) of $8, or $0.64 for each supplemental license purchased. Where first consumer 20 has purchased two (2) supplemental licenses, the consideration actually received by first consumer 20 is the potential consideration ($8), less the license administration center fee ($0.50), less two (2) supplemental license fees ($0.64 each), or $6.22.

In a preferred embodiment, the purchase price of a supplemental license from qualifying albums containing more than ten (10) associated music files (i.e. songs), is not a fixed percentage, but is instead a function of the number of songs associated with the relevant qualifying album. In the preferred embodiment, each purchase price of each supplemental license is equal to the potential consideration divided by the number of songs contained in the album. Thus, in the example of the preceding paragraph, where the potential consider was $8, if there were sixteen (16) song associated with the relevant qualifying album, the purchase price of each supplemental license would be $8 divided by sixteen (16) songs, or $0.50 per supplemental license. Where first consumer 20 has purchased two (2) supplemental licenses, the consideration actually received by first consumer 20 is the potential consideration ($8), less the license administration center fee ($0.50), less two (2) supplemental license fees ($0.50 each), or $6.50.

In a preferred embodiment, the purchase price of a supplemental license from library licenses, is also not a fixed percentage, but is instead a function of the number of music files (i.e. songs) associated with the library license. In the preferred embodiment, each purchase price of each supplemental license is equal to the potential consideration divided by the number of songs associated with the library license. Thus, in the example of the preceding two paragraphs, where the potential consider was $8, if there were fifty (50) songs associated with the relevant library license, the purchase price of each supplemental license would be $8 divided by fifty (50) songs, or $0.16 per supplemental license. Where first consumer 20 has purchased two (2) supplemental licenses, the consideration actually received by first consumer 20 is the potential consideration ($8), less the license administration center fee ($0.50), less two (2) supplemental license fees ($0.16 each), or $7.18.

In alternate embodiments, a fee is retained by license administration center 12 from the consideration paid for a supplemental license (either a fixed or a percentage of consideration received or provided). In other alternate embodiments, the purchase price of a supplemental license may be a different percentage of the consideration otherwise receivable by first consumer 20, a percentage of a different benchmark potentially including the consideration paid by second consumer 20, or a fixed fee. Alternate embodiments may also utilize a supplemental license purchase price that is a function of the number of songs on the relevant qualifying album.

In step 226, which occurs in conjunction with the sale of the first digital music license by first consumer 20 in the market as described in FIG. 3, license administration center terminates the first digital music license.

In preferred embodiments, license administration center 12 next records the termination of the first digital music license in license table 50 in step 228.

In the preferred embodiment, license termination in step 226 requires no action beyond step 228, as license administration center 12 references license table 50 prior to permitting any further streaming to first consumer 20 of qualified music files associated with the first digital music license. When license table 50 indicates that the first digital music license has been terminated, then license administration center 12 refuses any future requests for the streaming transfer of qualified music files associated with such license. In alternate embodiments, where license software is utilized, license administration center 12, or content provider 18 in response to instructions received from license administration center 12, may access such license software through network 14 and modify the license software to prohibit play of the qualified music file. In other alternate embodiments: (a) license software may automatically prevent future play of the relevant qualified music files if license administration center 12 or content provider 18 does not confirm (either on a fixed schedule or in association with a request to play such files) that first consumer 20 still owns the first digital music license; or (b) administration center 12 or content provider 18 may access the relevant qualified music files themselves and modify or delete such files so as to prevent future play (confirmation of such modification or deletion may be a prerequisite for receipt of consideration under step 120 of the method of FIG. 3.

Referring to FIG. 2, in preferred embodiments, license administration center 12 may implement rules and restrictions to help govern the primary and secondary markets. Such rules may be artist specific, or may be market wide. In the preferred embodiment, license administration center 12 prevents the market price of any digital music license from unreasonably exceeding retail prices, and the volume of any set of corresponding digital music licenses within the market may be increased to alleviate high consumer demand, by “splitting” existing digital music licenses within a corresponding set. License administration center 12 initiated a split when the market price for a digital music license (most preferably the weighted average price measured over a fixed period of time) reaches $16. As a result of the split, each existing digital music license with the set of corresponding licenses (then market priced at $16) is replaced by two (2) such licenses (initially priced at $8). In one preferred embodiment, a consumer holding the two (2) post-split digital music licenses may elect to receive the cash value of the additional digital music license ($8), less twenty percent (20%) payable to content provider 18 and $0.50 fee payable to license administration center 12, in lieu of such additional license. In alternate embodiments, the market price triggering a license split may be other than $16, the initial price for post-split license may be other than one-half of the pre-split price, and the split may create more than one additional license for each existing license. In the preferred embodiment, library licenses are not subject to license splits.

Though neither license administration center 12 nor content provider 18 receive direct consideration from the creation of new digital music licenses via an license split in the preferred embodiment (other than as the result of first consumer 20 exchanging a split-created digital music license for consideration as provided in the previous paragraph), the increased volume of digital music license on the market (at prices not unreasonably exceeding retail prices) increases the opportunity for content provider 18 and license administration center 12 to obtain revenue from secondary market sales.

In the absence of a license split mechanism, license prices may peak prematurely, as high license purchase prices reduce the music consumption purchase incentive, leaving only the market-based purchase incentives to drive demand.

In the preferred embodiment of the invention, license administration center 12 operates the market as a double blind bid/auction system. In addition, no bid is permitted to exceed the most recent bid for a given digital music license by more than 10%, artists are forbidden from purchasing their own licenses, and no consumer is permitted to hold more than fifty (50) digital music licenses within a corresponding license set. This limit on license holdings would operate by preventing additional acquisitions when a consumer already possesses fifty (50) digital music licenses within a corresponding license set, and by automatically liquidating excess digital music licenses should a license split cause holdings to unavoidably exceed the limit. These rules help to avoid market manipulation by consumers and, in the preferred embodiment, are subject to change by license administration center 12.

In preferred embodiments, license administration center 12 establishes a minimum digital music license price. In the preferred embodiment, such minimum price is $3.79.

Although the present invention has been described in several embodiments, a myriad of changes and modifications may be suggested to one skilled in the art, and it is intended that the present invention encompass such changes and modifications as fall within the scope of the present appended claims.

1. A system for use in operating a variably-priced secondary market for digital music licenses, comprising:
a memory;
a processor coupled to the memory;
and a computer program stored in the memory, the computer program operable, when executed on the processor, to:
receive an offer for the sale of a first digital music license from a first consumer;
receive a bid for the purchase of a second digital music license from a second consumer, the bid being greater than or equal to the offer of the second consumer, and the first digital music license corresponding to the second digital music license;
match the offer of the first consumer with the bid of the second consumer;
grant the second digital music license;
terminate the first digital music license;
obtain consideration from the second consumer for the purchase of the second digital music license; and
provide consideration to the first consumer for the sale of the first digital music license; the consideration provided to the first consumer being less than or equal to the consideration paid by the second consumer for the purchase of the second digital music license.

2. The system of claim 1, wherein:
the first digital music license is associated with a collection of musical works; and
and the program is further operable to:
receive information from the first consumer, prior to the termination of the first digital music license, requesting a supplemental digital music license to a subset of the collection of musical works, the supplemental digital license surviving the termination of the first digital music license;
grant the supplemental digital music license to the first consumer; and
obtain consideration from the first consumer for the purchase of the supplemental digital music license.

3. The system of claim 2, wherein the collection of works is an album of songs; and the supplemental digital music license is associated with a song from the album.

4. The system of claim 2, wherein the collection of works is a library of songs; and the supplemental digital music license is associated with a song from the library.

5. The system of claim 2, wherein the consideration paid by the first consumer for the purchase of the supplemental digital music license is paid through a reduction in the consideration provided to the first consumer for the sale of the first digital music license.

6. The system of claim 2 further comprising:
a first monetary account stored in the memory and associated with the first consumer; and
a second monetary account stored in memory and associated with the second consumer,
wherein the program is further operable to deduct any consideration paid by the second consumer the second monetary account, and add any consideration provided to the first consumer to the first monetary account.

7. The system of claim 1 further comprising a license table stored in the memory, and wherein the program is further operable to:
record the grant of the second digital music license to the second consumer in the license table; and
record the termination of the first digital music license in the license table.

8. The system of claim 7, wherein:
the first digital music license and the second digital music license correspond by being associated with the same musical artist; and
the program is further operable to:
receive a request from the first consumer, prior to the termination of the first digital music license, to associate the first digital music license to an album of the musical artist;
record, within the license table, the association of first digital music license with the album requested by the first consumer.
receive a request from the second consumer to associate the second digital music license to an album of the musical artist;
record, within the license table, the association of the second digital music license with the album requested by the second consumer.

9. The system of claim 8, wherein the program is further operable to:
receive information from the first consumer, prior to the termination of the first digital music license, requesting a supplemental digital music license to a song of the album associated with the first digital music license, the supplemental digital license surviving the termination of the first digital music license;
grant the supplemental digital music license to the first consumer; and
obtain consideration from the first consumer for the purchase of the supplemental digital music license.

10. The system of claim 9, wherein the program is further operable to record the grant of the supplemental digital music license to the first consumer in the license table.

11. The system of claim 10 further comprising:
a first monetary account stored in the memory and associated with the first consumer; and
a second monetary account stored in memory and associated with the second consumer,
wherein the program is further operable to deduct any consideration paid by the second consumer the second monetary account, and add any consideration provided to the first consumer to the first monetary account.

12. The system of claim 1, further comprising a music file warehouse stored in the memory, and wherein, prior to the termination of the first digital music license, the program is further operable to transmit a music file associated with the first digital music license, from the music file warehouse to the first consumer, and such music filed is stored in a consumer memory by the first consumer.

13. The system of claim 12, wherein the music file is transmitted to the second consumer using a progressive downloading technique.

14. The system of claim 12, wherein, prior to the termination of the first digital music license, the program is further operable to transmit license software associated with the music file to the first consumer, and such license software is stored in a consumer memory by the first consumer.

15. The system of claim 14, wherein, the program is further operable to receive requests from the license software to confirm that the first consumer owns the first digital music license, prior to such license software permitting the first consumer to play the music file.

16. The system of claim 14, wherein the program is further operable to record the termination of the first digital music license by accessing and modifying the license software in the consumer memory so as to no longer permit the first consumer to play the music file.

17. The system of claim 14, wherein the program is further operable to:
receive information from the first consumer, prior to the termination of the first digital music license, requesting a supplemental digital music license to a song of the album associated with the first digital music license, the supplemental digital license surviving the termination of the first digital music license;
grant the supplemental digital music license to the first consumer;
obtain consideration from the first consumer for the purchase of the supplemental digital music license.

18. The system of claim 17, wherein the program is further operable to transmit a music file associated with the supplemental license, and such music filed is stored in a consumer memory by the first consumer.

19. The system of claim 17, wherein the program is further operable to record the grant of the supplemental license to the first consumer by accessing and modifying the license software in the consumer memory so as to permit the first consumer to play the music file after the termination of the first music license.

20. The system of claim 17 further comprising:
a first monetary account stored in the memory and associated with the first consumer; and
a second monetary account stored in memory and associated with the second consumer,
wherein the program is further operable to deduct any consideration paid by the second consumer the second monetary account, and add any consideration provided to the first consumer to the first monetary account.

21. A method, performed on a computer, for operating a variably-priced secondary market for digital music licenses, comprising:
receiving an offer for the sale of a first digital music license from a first consumer;
receiving a bid for the purchase of a second digital music license from a second consumer, the bid being greater than or equal to the offer of the second consumer, and the first digital music license corresponding to the second digital music license;
matching the offer of the first consumer with the bid of the second consumer;
granting the second digital music license;
terminating the first digital music license;
obtaining consideration from the second consumer for the purchase of the second digital music license; and
providing consideration to the first consumer for the sale of the first digital music license; the consideration provided to the first consumer being less than or equal to the consideration paid by the second consumer for the purchase of the second digital music license.

22. The method of claim 21, wherein the first digital music license is associated with a collection of musical works; the method further comprising:
receiving information from the first consumer, prior to the termination of the first digital music license, requesting a supplemental digital music license to a subset of the collection of musical works, the supplemental digital license surviving the termination of the first digital music license;
granting the supplemental digital music license to the first consumer; and
obtaining consideration from the first consumer for the purchase of the supplemental digital music license.

23. The method of claim 22, wherein the collection of works is an album of songs; and the supplemental digital music license is associated with a song from the album.

24. The method of claim 22, wherein the collection of works is a library of songs; and the supplemental digital music license is associated with a song from the library.

25. The method of claim 22, wherein the consideration paid by the first consumer for the purchase of the supplemental digital music license is paid through a reduction in the consideration provided to the first consumer for the sale of the first digital music license.

26. The method of claim 22 wherein any consideration paid by the second consumer is deducted from a second monetary account associated with the second consumer, and any consideration provided to the first consumer is added to a first monetary account associated with the first consumer.

27. The method of claim 21 further comprising:
recording the grant of the second digital music license to the second consumer in a license table; and
recording the termination of the first digital music license in the license table.

28. The method of claim 27, wherein:
the first digital music license and the second digital music license correspond by being associated with the same musical artist; and
the method further comprises:
receiving a request from the first consumer, prior to the termination of the first digital music license, to associate the first digital music license to an album of the musical artist;
recording, within the license table, the association of first digital music license with the album requested by the first consumer.
receiving a request from the second consumer to associate the second digital music license to an album of the musical artist;
recording, within the license table, the association of the second digital music license with the album requested by the second consumer.

29. The method of claim 28, further comprising:
receiving information from the first consumer, prior to the termination of the first digital music license, requesting a supplemental digital music license to a song of the album associated with the first digital music license, the supplemental digital license surviving the termination of the first digital music license;
granting the supplemental digital music license to the first consumer; and
obtaining consideration from the first consumer for the purchase of the supplemental digital music license.

30. The method of claim 29, further comprising:
recording the grant of the supplemental digital music license to the first consumer in the license table.

31. The method of claim 30 wherein any consideration paid by the second consumer is deducted from a second monetary account associated with the second consumer, and any consideration provided to the first consumer is added to a first monetary account associated with the first consumer.

32. The method of claim 21 further comprising:
transmitting, prior to the termination of the first digital music license, a music file associated with the first digital music license, from a music file warehouse to the first consumer.

33. The method of claim 32, wherein the music file is transmitted to the second consumer using a progressive downloading technique.

34. The method of claim 32 further comprising:
transmitting, prior to the termination of the first digital music license, license software associated with the music file to the first consumer.

35. The method of claim 34, further comprising:
receiving requests from the license software to confirm that the first consumer owns the first digital music license, prior to such license software permitting the first consumer to play the music file.

36. The method of claim 34, further comprising:
recording the termination of the first digital music license by accessing and modifying the license software so as to no longer permit the first consumer to play the music file.

37. The method of claim 34, further comprising:
receiving information from the first consumer, prior to the termination of the first digital music license, requesting a supplemental digital music license to a song of the album associated with the first digital music license, the supplemental digital license surviving the termination of the first digital music license;
granting the supplemental digital music license to the first consumer;
obtaining consideration from the first consumer for the purchase of the supplemental digital music license.

38. The method of claim 37, further comprising:
transmitting a music file associated with the supplemental license to the first consumer.

39. The method of claim 37, further comprising:
record the grant of the supplemental license to the first consumer by accessing and modifying the license software so as to permit the first consumer to play the music file after the termination of the first music license.

40. The method of claim 37 wherein any consideration paid by the second consumer is deducted from a second monetary account associated with the second consumer, and any consideration provided to the first consumer is added to a first monetary account associated with the first consumer.
